(19) United States
(12) Patent Application Publication
(10) Pub. No.: US 2026/0057835 A1
(43) Pub. Date: Feb. 26, 2026

(54) DISPLAY APPARATUS AND ELECTRONIC DEVICE INCLUDING THE SAME

(71) Applicant: Samsung Display Co., Ltd., Yongin-Si (KR)

(72) Inventors: Hanbit Kim, Yongin-si (KR); Meejae Kang, Yongin-si (KR); Jiyeong Shin, Yongin-si (KR); Yunjung Oh, Yongin-si (KR); Kiseok Choi, Yongin-si (KR); Sanggun Choi, Yongin-si (KR)

(21) Appl. No.: 19/305,023

(22) Filed: Aug. 20, 2025

(30) Foreign Application Priority Data
Aug. 23, 2024 (KR) 10-2024-0113706

(51) Int. Cl. G09G 3/3233

(52) U.S. Cl. CPC G09G 3/3233; G09G 2300/0452; G09G 2300/0465; G09G 2300/0819; G09G 2300/0852; G09G 2300/0861; G09G 2310/08

(57) ABSTRACT

A display apparatus includes a plurality of pixels connected to gate control lines and data lines. Each of the plurality of pixels may include first to third display elements emitting light of different colors, a first transistor having a gate connected to a first node, a first terminal connected to a first voltage line, and a second terminal connected to a second node, a first emission control transistor connected between the second node and the first display element, a second emission control transistor connected between the second node and the second display element, and a third emission control transistor connected between the second node and the third display element. A same emission control signal may be supplied to the corresponding emission control transistor included in each of the plurality of pixels.

### CROSS-REFERENCE TO RELATED APPLICATION

This application is based on and claims priority under 35 U.S.C. § 119 to Korean Patent Application No. 10-2024-0113706, filed on Aug. 23, 2024, in the Korean Intellectual Property Office, the disclosure of which is incorporated by reference herein in its entirety.

### BACKGROUND

### 1. Field

The present disclosure relates to display apparatuses and electronic devices including the same.

### 2. Description of the Related Art

Recently, the use of display apparatuses has diversified. In addition, as display apparatuses have become thinner in thickness and lighter in weight, a range of their usage has widened.

Such display apparatuses may include transistors, capacitors, and lines to control a luminance of each pixel. As display apparatuses have been used in various ways, display apparatuses have been designed in various shapes.

### SUMMARY

The present disclosure may include a display apparatus and an electronic device with improved display quality. However, this feature of the present disclosure is only an example, and the scope of the disclosure is not limited thereto.

Additional aspects will be set forth in the description which follows and will be apparent from the description.

According to an embodiment, a display apparatus includes a plurality of gate control lines, a plurality of data lines and a plurality of pixels connected to the gate control lines and the data lines. Each of the plurality of pixels may include first display element, second display element and third display element, each of which emits light of different colors, a first transistor having a gate connected to a first node, a first terminal connected to a first voltage line, and a second terminal connected to a second node, a first emission control transistor connected between the second node and the first display element, a second emission control transistor connected between the second node and the second display element, and a third emission control transistor connected between the second node and the third display element. A same first emission control signal is supplied to the first emission control transistor included in each of the plurality of pixels, a same second emission control signal is supplied to the second emission control transistor included in each of the plurality of pixels, and a same third emission control signal is supplied to the third emission control transistor included in each of the plurality of pixels.

According to an embodiment, a single frame may include first sub-frame, second sub-frame and third sub-frame. The first sub-frame may include a first non-emission period in which a data signal corresponding to the first display element is written, and a first emission period in which the first display element emits light. The second sub-frame may include a second non-emission period in which a data signal corresponding to the second display element is written, and a second emission period in which the second display element emits light. The third sub-frame may include a third non-emission period in which a data signal corresponding to the third display element is written, and a third emission period in which the third display element emits light.

According to an embodiment, data signals may be sequentially written to the plurality of pixels for each row during the first to third non-emission periods.

According to an embodiment, the first display elements in each of the plurality of pixels may simultaneously emit light during the first emission period, the second display elements in each of the plurality of pixels may simultaneously emit light during the second emission period, and the third display elements in each of the plurality of pixels may simultaneously emit light during the third emission period.

According to an embodiment, each of the plurality of pixels may further include a second transistor connected between the second node and a third node, a third transistor connected between the first node and the third node, a first capacitor connected between an initialization voltage line and the first node, and a second capacitor connected between a data line and the third node.

According to an embodiment, a first driving voltage supplied via the first voltage line may have a variable voltage level.

According to an embodiment, each of the first to third display elements may include a pixel electrode, an opposite electrode disposed on the pixel electrode, and an intermediate layer disposed between the pixel electrode and the opposite electrode. A second driving voltage supplied to the opposite electrode may have a variable voltage level.

According to an embodiment, the second driving voltage may have a first voltage during the first to third non-emission periods, and the second driving voltage may have a second voltage, which is lower than the first voltage, during the first to third emission periods.

According to an embodiment, the initialization voltage supplied via the initialization voltage line may have a variable voltage level.

According to an embodiment, a column in which the first display element is arranged, a column in which the second display element is arranged, and a column in which the third display element is arranged may be alternately disposed with each other in a row direction.

According to an embodiment, a display apparatus includes a plurality of gate control lines, a plurality of data lines and a plurality of pixels connected to the gate control lines and the data lines. Each of the plurality of pixels may include first display element, second display element, third display element and fourth display element, each of which emits light of one color among a first color, a second color, and a third color, wherein the first color, the second color, and the third color are different colors, a first pixel circuit including a first transistor connected to a first voltage line, a first emission control transistor connected between the first transistor and the first display element, and a second emission control transistor connected between the first transistor and the second display element, and a second pixel circuit including a first transistor connected to the first voltage line, a third emission control transistor connected between the first transistor and the third display element, and a fourth emission control transistor connected between the first transistor and the fourth display element. A same first emission control signal may be supplied to the first emission control transistor and the third emission control transistor included in each of the plurality of pixels, and a same second emission control signal is supplied to the second emission control transistor and the fourth emission control transistor included in each of the plurality of pixels.

According to an embodiment, a single frame may include first sub-frame and second sub-frame. The first sub-frame may include a first non-emission period in which a data signal corresponding to the first display element and the third display element is written, and a first emission period in which the first display element and the third display element emit light. The second sub-frame may include a second non-emission period in which a data signal corresponding to the second display element and the fourth display element is written, and a second emission period in which the second display element and the fourth display element emit light.

According to an embodiment, during each of the first non-emission period and the second non-emission period, data signals may be sequentially written to the plurality of pixels for each row.

According to an embodiment, the first display element and the third display element in each of the plurality of pixels may simultaneously emit light during the first emission period, and the second display element and the fourth display element in each of the plurality of pixels may simultaneously emit light during the second emission period.

According to an embodiment, the first transistor may have a gate connected to a first node, a first terminal connected to the first voltage line, and a second terminal connected to a second node. Each of the first pixel circuit and the second pixel circuit may include a second transistor connected between the second node and a third node, a third transistor connected between the first node and the third node, a first capacitor connected between an initialization voltage line and the first node, and a second capacitor connected between a data line and the third node.

According to an embodiment, a first driving voltage supplied via the first voltage line may have a variable voltage level.

According to an embodiment, each of the first to fourth display elements may include a pixel electrode, an opposite electrode disposed on the pixel electrode, and an intermediate layer disposed between the pixel electrode and the opposite electrode. A second driving voltage supplied to the opposite electrode may have a variable voltage level.

According to an embodiment, a second driving voltage may have a first voltage during the first to second non-emission periods, and the second driving voltage may have a second voltage, which is lower than the first voltage, during the first to second emission periods.

According to an embodiment, the first display element may emit red light, the second display element may emit blue light, and the third display element and the fourth display element may emit green light.

According to an embodiment, the first display element may emit red light, the third display element may emit blue light, and the second display element and the fourth display element may emit green light.

According to an embodiment, an electronic device includes a processor providing input image data and a display apparatus displaying an image based on the input image data. The display apparatus may include a plurality of pixels connected to gate control lines and data lines. Each of the plurality of pixels may include first display element, second display element, third display element, each of which emits light of different colors, a first transistor having a gate connected to a first node, a first terminal connected to a first voltage line and a second terminal connected to a second node, a first emission control transistor connected between the second node and the first display element, a second emission control transistor connected between the second node and the second display element, and a third emission control transistor connected between the second node and the third display element. A same first emission control signal may be supplied to the first emission control transistor included in each of the plurality of pixels, a same second emission control signal may be supplied to the second emission control transistor included in each of the plurality of pixels, and a same third emission control signal may be supplied to the third emission control transistor included in each of the plurality of pixels.

According to an embodiment, the display apparatus may be included in one of a mobile phone, a smartphone, a tablet personal computer (PC), a mobile communication terminal, an electronic notebook, an electronic book, a portable multimedia player, a navigation, an ultra mobile PC, a television, a laptop, a monitor, a billboard, an Internet of things device, a smart watch, a watch phone, a glasses-type display, a head-mounted display, an instrument panel for a vehicle, a center fascia for a vehicle, a center information display, and a room-mirror display for a vehicle.

The aspects or features of the present disclosure will become apparent and more readily appreciated from the following detailed description of the embodiments, the accompanying drawings, and the claims.

### BRIEF DESCRIPTION OF THE DRAWINGS

The above and other aspects, features, and advantages of the present disclosure will become more apparent with reference to the following description taken in conjunction with the accompanying drawings.

FIG. 1 is a plan view schematically illustrating a display apparatus according to an embodiment.

FIG. 2 is a block diagram schematically illustrating a display apparatus according to an embodiment.

FIG. 3 is a plan view illustrating region I of the display apparatus shown in FIG. 1.

FIG. 4 is an equivalent circuit diagram schematically illustrating a pixel according to an embodiment.

FIG. 5 is a timing diagram showing an operation of the pixel shown in FIG. 4.

FIG. 6 is a diagram schematically illustrating an image displayed during a single frame.

FIGS. 7A to 7C are diagrams schematically illustrating images displayed during the respective sub-frames.

FIG. 8 is a plan view illustrating region I of the display apparatus shown in FIG. 1.

FIG. 9 is an equivalent circuit diagram schematically illustrating a pixel according to an embodiment.

FIG. 10 is a timing diagram showing an operation of the pixel shown in FIG. 9.

### DETAILED DESCRIPTION

Hereinafter, specific embodiments of the present disclosure are explained in detail with reference to the accompanying drawings. Like numerals refer to like elements throughout. In this regard, embodiments of the present disclosure may have different forms and should not be construed as being limited to the descriptions set forth herein. Accordingly, the embodiments are merely described below, by referring to the drawings, to explain aspects of the present disclosure. As used herein, the word “or” means logical “or” so that, unless the context indicates otherwise, the expression “A, B, or C” means “A and B and C,” “A and B but not C,” “A and C but not B,” “B and C but not A,” “A but not B and not C,” “B but not A and not C,” and “C but not A and not B.”

As the present disclosure allows for various changes and can have numerous embodiments, specific embodiments will be illustrated in the drawings and described in detail in the written description. Hereinafter, the effects and features of the present disclosure as well as a method for accomplishing them will be described more fully with reference to the accompanying drawings, in which embodiments of the present disclosure are shown. The present disclosure may, however, be embodied in many different forms and should not be construed as limited to the embodiments set forth herein.

Embodiments of the present disclosure are described below in more detail with reference to the accompanying drawings. Those elements that are the same as or similar to in their functionalities or structures, etc. are denoted using the same reference numeral regardless of the figure number, and redundant descriptions thereof are omitted.

Terms such as “first” and “second” as used herein are used herein merely to describe specific elements of the present disclosure, but the elements are not limited by the terms. Such terms are used only for the purpose of distinguishing one element from another element.

The singular expression, such as “a” and “an,” used herein are intended to include plural forms, unless it has a clearly different meaning in the context.

The term, such as “include” or “comprise,” may be construed to indicate the presence of a certain characteristic or element, or a combination thereof, but may not be construed to exclude the existence of or a possibility of addition of one or more other characteristics, elements, or combinations thereof.

It will be understood that when a layer, region, or elements is referred to as being “formed on” another layer, region, or element, it can be directly or indirectly formed on the other layer, region, or element. That is, for example, intervening layers, regions, or elements may be present.

It will be understood that when a layer, region, or element is referred to as being “connected” to another layer, region, or element, it may be “directly connected” to the other layer, region, or element, or may be “indirectly connected” to the other layer, region, or element with other layer, region, or element therebetween. For example, it will be understood that when a layer, region, or element is referred to as being “electrically connected” to another layer, region, or element, it may be “directly electrically connected” to the other layer, region, or element, or may be “indirectly electrically connected” to other layer, region, or element with other layer, region, or element therebetween.

Herein, “A or B” means A or B, or A and B. In addition, “at least one of A and B” means A or B, or A and B.

The x-direction, the y-direction, and the z-direction are not limited to directions according to three axes of the rectangular coordinate system, and may be interpreted in a broader sense. For example, the x-direction, the y-direction, and the z-direction may be perpendicular to one another, or may represent different directions that are not perpendicular to one another.

The term “in a plan view” means that the target portion is viewed from above (e.g., when viewed in a direction perpendicular to the upper surface of the substrate), and the term “in a cross-sectional view” means that a vertically-cut cross-section of the target portion is viewed from the side.

When a first component is said to “overlap” a second component, it means that the first component is positioned over or under the second component so that at least a portion of the first component overlaps the second component in a plan view.

Herein, “ON” used in connection with a state of an element may refer to an activated state of the element, and “OFF” may refer to a deactivated state of the element. “ON” when used in connection with a signal received by an element may refer to a signal that activates the element, and “OFF” may refer to a signal that deactivates the element. The element can be activated by a high-level voltage or a low-level voltage. For example, a P-channel transistor (P-type transistor) is activated by a low-level voltage, and an N-channel transistor (N-type transistor) is activated by a high-level voltage. Therefore, it is important to understand that the “ON” voltages for P-type and N-type transistors have opposite (low vs. high) voltage levels.

The order of the process or method understood in the description of the processing process, manufacturing method, etc. may be different from the described order. For example, two consecutively described processes may be performed substantially at the same time or performed in an order opposite to the described order.

Sizes of elements in the drawings may be exaggerated or reduced for convenience of explanation. For example, since sizes and thicknesses of elements in the drawings are arbitrarily illustrated for convenience of explanation, the present disclosure is not limited thereto.

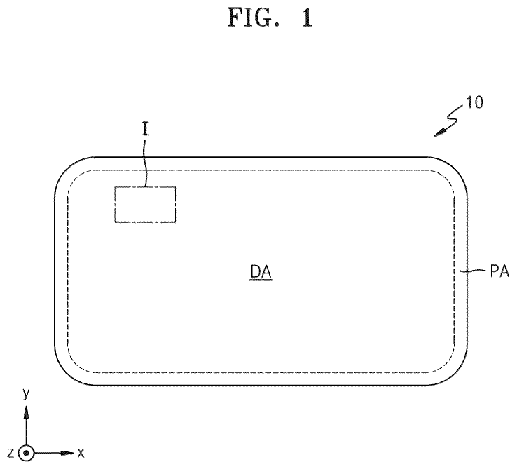

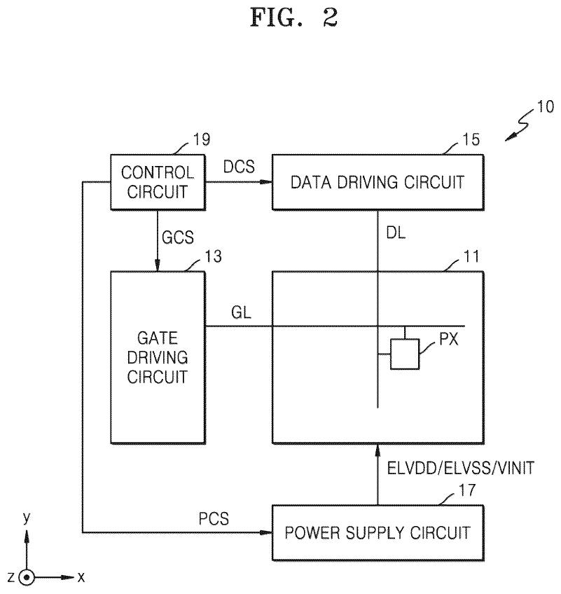

FIG. 1 is a plan view schematically illustrating a display apparatus 10 according to an embodiment, and FIG. 2 is a block diagram schematically illustrating the display apparatus 10 according to an embodiment.

Referring to FIG. 1, the display apparatus 10 may include a display area DA on which an image is displayed, and a peripheral area PA outside the display area DA. The display area DA may be entirely surrounded by the peripheral area PA.

In a plan view, the display area DA may have a rectangular shape. In an embodiment, the display area DA may have a polygonal shape, such as a triangle, a pentagon, or a hexagon, a circular shape, an elliptical shape, or an irregular shape. The display area DA may have round corners. In an embodiment, the display apparatus 10 may have the display area DA having a length in a second direction (y-direction or column direction) shorter than a length in a first direction (x-direction or row direction), as shown in FIG. 1. In an embodiment, the display apparatus 10 may have the display area DA having the length in the second direction (y-direction) longer than the length in the first direction (x-direction).

The display apparatus 10 according to an embodiment is an apparatus for displaying moving images or still images, and may be incorporated into not only portable electronic devices, such as mobile phones, smartphones, tablet personal computers (PCs), mobile communication terminals, electronic notebooks, electronic books, portable multimedia players (PMPs), navigations, or ultra mobile PCs (UMPCs), but also various electronic devices, such as televisions, laptops, monitors, billboards, or Internet of things (IoT). Furthermore, the display apparatus 10 according to an embodiment may be used for wearable electronic devices, such as smart watches, watch phones, glasses-type displays, or head-mounted displays (HMDs). In addition, the display apparatus 10 according to an embodiment may be incorporated into an instrument panel for a vehicle, such as a center information display (CID) disposed on a center fascia or a dashboard of a vehicle, a room mirror display replacing side-view mirrors of a vehicle, or as a display disposed on the rear surface of a front seat for an entertainment for the backseat of a vehicle. In addition, the display apparatus 10 may be a flexible apparatus.

Referring to FIG. 2, the display apparatus 10 may include a pixel unit 11, a gate driving circuit 13, a data driving circuit 15, a power supply circuit 17, and a control circuit 19.

The pixel unit 11 may include a plurality of gate control lines GL, a plurality of data lines DL, and a plurality of pixels PX connected to the plurality of gate control lines GL and the plurality of data lines DL.

The plurality of pixels PX may be disposed in various shapes, such as a stripe array, a PenTile™ array (diamond array), or a mosaic array, so as to implement an image. The pixel unit 11 may be disposed in a display area of a substrate. Each of the pixels PX may include an organic light-emitting diode as a display element, and the organic light-emitting diode may be connected to a display circuit. The pixel circuit may include a plurality of transistors and at least one capacitor.

Each of the pixels PX may emit, for example, red, green, blue, or white light through the organic light-emitting diode. Each of the pixels PX may be connected to at least one corresponding gate control line from among the plurality of gate control lines GL and a corresponding data line from among the plurality of data lines DL.

Each of the gate control lines GL may extend in the first direction (x-direction) and may be connected to pixels PX in a same row. Each of the gate control lines GL may be configured to transfer a gate signal to the pixels PX in the same row. Each of the data lines DL may extend in the second direction (y-direction) and may be connected to pixels PX in a same column. Each of the data lines DL may be configured to transfer a data signal to the pixels PX in the same column.

The gate driving circuit 13 may be connected to the plurality of gate control lines GL and may generate a gate signal in response to a control signal GCS from the control circuit 19, and sequentially supply the generated gate signal to the gate control lines GL. The gate control line GL may be connected to a gate of a transistor included in the pixel PX. The gate signal may be a gate control signal for turning-on and turning-off a transistor having a gate connected to the gate control line GL. The gate signal may be a square wave signal including an on voltage for turning on the transistor and an off voltage for turning off the transistor. In an embodiment, the on voltage may be a high-level voltage (first-level voltage) or a low-level voltage (second-level voltage). A period for which the on voltage of the gate signal is maintained (hereinafter referred to as “on-voltage period”) and a period for which the off voltage is maintained (hereinafter referred to as “off-voltage period”) may be determined according to a function of a transistor receiving a scan signal within the pixel PX.

The data driving circuit 15 may be connected to the plurality of data lines DL and may supply a data signal to the data lines DL in response to a control signal DCS from the control circuit 19. The data signal may be supplied to the pixels PX through the data lines DL.

The power supply circuit 17 may generate a voltage required for driving the pixel PX, in response to a control signal PCS from the control circuit 19. When the display apparatus 10 is an organic electroluminescence display apparatus, the power supply circuit 17 may supply a first driving voltage ELVDD and a second driving voltage ELVSS to the pixels PX of the pixel unit 11. The first driving voltage ELVDD may be a voltage provided to a first electrode (pixel electrode or anode electrode) of a display element included in the pixel PX. The second driving voltage ELVSS may be a voltage provided to a second electrode (opposite electrode or cathode electrode) of the display element included in the pixel PX. The power supply circuit 17 may supply an initialization voltage VINIT to the pixels PX of the pixel unit 11. The first driving voltage ELVDD, the second driving voltage ELVSS, and the initialization voltage VINIT may have voltage levels that vary during one frame.

The control circuit 19 may generate the control signals GCS, DCS, and PCS based on signals including input image data and a control signal received from a host or a processor (not shown in the drawings). The control circuit 19 may generate the control signal GCS, DCS, and PCS based on the control signal received from the host or the processor, and supply the generated control signals GCS, DCS, and PCS to the gate driving circuit 13, the data driving circuit 15, and the power supply circuit 17. The control signal GCS output to the gate driving circuit 13 may include a plurality of clock signals and a scan start signal. The control signal DCS output to the data driving circuit 15 may include a source start signal and clock signals. The control circuit 19 may convert the input image data received from the host or the processor to generate data signal and transfer the data signal to the pixels PX of the display unit 11 in order for the display apparatus 10 to display image based on the input image data.

The display apparatus 10 may include a display panel, and the display panel may include a substrate. The display apparatus 10 may include the display area DA (see FIG. 1) on which images are displayed, and the peripheral area PA surrounding the display area DA. The pixel unit 11 may be disposed in the display area DA of the substrate, and outer circuits, such as the gate driving circuit 13, the data driving circuit 15, and the power supply circuit 17, may be disposed in the peripheral area PA. For example, all or part of the gate driving circuit 13 may be directly formed in the peripheral area PA of the substrate during a process of forming a transistor constituting the pixel circuit in the display area DA of the substrate. The data driving circuit 15 may be disposed on a flexible printed circuit board (FPCB) electrically connected to a pad disposed on one side of the substrate. In an embodiment, the data driving circuit 15 may be disposed directly on the substrate in a chip on glass (COG) or chip on plastic (COP) manner.

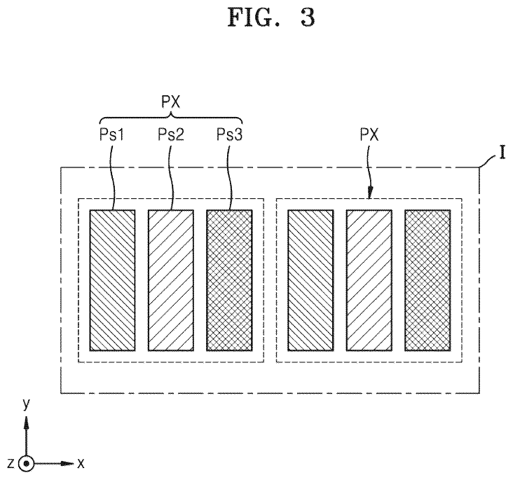

FIG. 3 is a plan view illustrating region I of the display apparatus 10 shown in FIG. 1.

Referring to FIG. 3, the plurality of pixels PX may be disposed in the display area DA (see FIG. 1) of the display apparatus 10 (see FIG. 1). The pixels PX may be arranged in the first direction (x-direction) and the second direction (y-direction).

A single pixel PX may include sub-pixels Ps1, Ps2, and Ps3, which emit light of different colors. In an embodiment, the first sub-pixel Ps1 may emit red light, the second sub-pixel Ps2 may emit green light, and the third sub-pixel Ps3 may emit blue light. The sub-pixels Ps1, Ps2, and Ps3 shown in FIG. 3 indicate emission areas of corresponding display elements, respectively.

In an embodiment, the pixels PX may be disposed in a stripe array. For example, the first sub-pixel Ps1, the second sub-pixel Ps2, and the third sub-pixel Ps3, which are included in the same pixel PX, may be spaced apart from each other in the first direction (x-direction). In the display area DA, a column in which the first sub-pixels Ps1 are arranged in the second direction (y-direction), a column in which the second sub-pixels Ps2 are arranged in the second direction (y-direction), and a column in which the third sub-pixels Ps3 are arranged in the second direction (y-direction) may be alternately arranged with each other in the first direction (x-direction or row direction).

When a distance between the eyes of a user and a display apparatus is small, as in the case of an HMD, a pixel per degree (PPD) of the display apparatus 10 may be reduced. In a low-PPD environment, the display apparatus 10 including the pixels PX disposed in a stripe array may display text or line patterns more clearly.

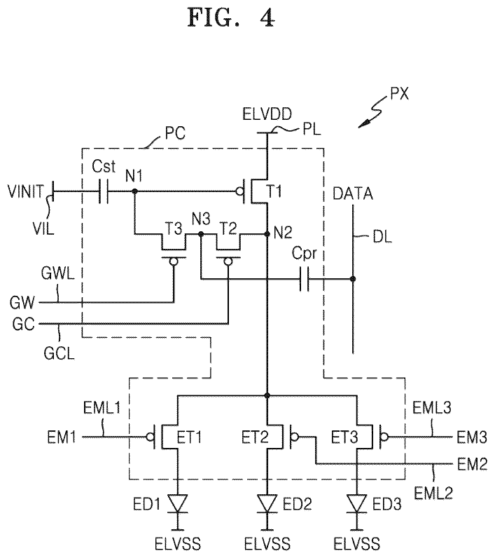

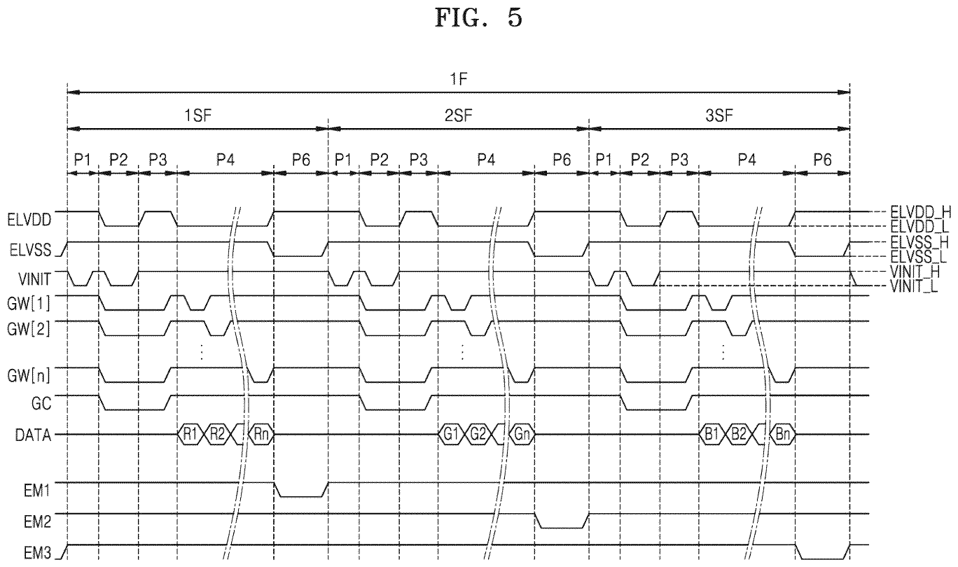

FIG. 4 is an equivalent circuit diagram schematically illustrating a pixel PX according to an embodiment, and FIG. 5 is a timing diagram showing driving of the pixel PX shown in FIG. 4.

Referring to FIG. 4, the pixel PX may include a pixel circuit PC and a plurality of organic light-emitting diodes as a display element connected to the pixel circuit PC. The plurality of organic light-emitting diodes may include a first display element ED1, a second display element ED2, and a third display element ED3. In an embodiment, the first display element ED1 may constitute the first sub-pixel Ps1, the second display element ED2 may constitute the second sub-pixel Ps2, and the third display element ED3 may constitute the third sub-pixel Ps3.

The pixel circuit PC may include a first transistor T1, a second transistor T2, a third transistor T3, a first emission control transistor ET1, a second emission control transistor ET2, a third emission control transistor ET3, a first capacitor Cst, and a second capacitor Cpr, each of which are connected to a plurality of signal lines. The signal lines may include a data line DL, a first gate line GWL, a second gate line GCL, an initialization voltage line VIL, a first emission control line EML1, a second emission control line EML2, a third emission control line EML3, and a driving voltage line PL. The first gate line GWL, the second gate line GCL, the first emission control line EML1, the second emission control line EML2, and the third emission control line EML3 may be gate control lines to which a gate signal for turning-on or turning-off a transistor is transmitted.

According to an embodiment, transistors included in the pixel circuit PC may be p-type silicon thin-film transistors. The silicon thin-film transistor may be a low temperature poly-silicon (LTPS) thin-film transistor in which an active pattern (semiconductor layer) includes amorphous silicon, polysilicon, or the like.

The first transistor T1 may be a driving transistor, and the second transistor T2, the third transistor T3, the first emission control transistor ET1, the second emission control transistor ET2, and the third emission control transistor ET3 may be switching transistors. A first terminal (first electrode) of each of the first transistor T1, the second transistor T2, the third transistor T3, the first emission control transistor ET1, the second emission control transistor ET2, and the third emission control transistor ET3 may be a source or a drain, and a second terminal (second electrode) may be a different terminal than the first terminal. For example, when the first terminal is the source (source electrode), the second terminal may be the drain (drain electrode). In an embodiment, the source and the drain may be interchangeably referred to as the source electrode and the drain electrode, respectively. A node to which the gate of the first transistor T1 is connected may be defined as a first node N1, and a node to which the second terminal of the first transistor T1 is connected may be defined as a second node N2. A node to which the second terminal of the second transistor T2 and the first terminal of the third transistor T3 are connected may be defined as a third node N3.

The first transistor T1 may be connected to the driving voltage line PL. The first transistor T1 may include a gate connected to the first node N1, a first terminal connected to the driving voltage line PL, and a second terminal connected to the second node N2.

The second transistor T2 may be connected between the second node N2 and the third node N3. The second transistor T2 may include a gate connected to the second gate line GCL, a first terminal connected to the second node N2, and a second terminal connected to the third node N3.

The third transistor T3 may be connected in series with the second transistor T2. The third transistor T3 may be connected between the third node N3 and the first node N1. The third transistor T3 may include a gate connected to the first gate line GWL, a first terminal connected to the third node N3, and a second terminal connected to the first node N1.

The first emission control transistor ET1 may be connected between the second node N2 and the first display element ED1. The first emission control transistor ET1 may include a gate connected to the first emission control line EML1, a first terminal connected to the second node N2, and a second terminal connected to the first display element ED1.

The second emission control transistor ET2 may be connected between the second node N2 and the second display element ED2. The second emission control transistor ET2 may include a gate connected to the second emission control line EML2, a first terminal connected to the second node N2, and a second terminal connected to the second display element ED2.

The third emission control transistor ET3 may be connected between the second node N2 and the third display element ED3. The third emission control transistor ET3 may include a gate connected to the third emission control line EML3, a first terminal connected to the second node N2, and a second terminal connected to the third display element ED3.

The first capacitor Cst may be connected between the first node N1 and the initialization voltage line VIL. The first capacitor Cst may include a first electrode connected to the first node N1 and a second electrode connected to the initialization voltage line VIL.

The second capacitor Cpr may be connected between the data line DL and the third node N3. The second capacitor Cpr may include a first electrode connected to the data line DL and a second electrode connected to the third node N3. A capacitance of the second capacitor Cpr may be greater than a capacitance of the first capacitor Cst.

Each of the first display element ED1, the second display element ED2, and the third display element ED3 may include a pixel electrode, an opposite electrode, and an intermediate layer disposed between the pixel electrode and the opposite electrode. The opposite electrode may receive the second driving voltage ELVSS.

The pixel PX may display an image for each frame period. Referring to FIG. 5, a single frame 1F may include a plurality of sub-frames. The single frame 1F may include a first sub-frame 1SF, a second sub-frame 2SF, and a third sub-frame 3SF.

Each of the first sub-frame 1SF, the second sub-frame 2SF, and the third sub-frame 3SF may include a bias period P1, an initialization period P2, a compensation period P3, a write period P4, and an emission period P6. The bias period P1, the initialization period P2, the compensation period P3, and the write period P4 may be non-emission periods in which none of the pixels PX emit light. During the bias period P1, the initialization period P2, the compensation period P3, and the emission period P6, all of the pixels PX disposed in the pixel unit 11 may be driven simultaneously, and during the write period P4, the pixels PX may be sequentially driven in rows.

The first driving voltage ELVDD supplied via the driving voltage line PL, the initialization voltage VINIT supplied via the initialization voltage line VIL, and the second driving voltage ELVSS supplied to the opposite electrode may have voltage levels that vary within one frame period. For example, the first driving voltage ELVDD may have a first voltage ELVDD_L or a second voltage ELVDD_H which is greater than a voltage level of the first voltage ELVDD_L during one frame period. The second driving voltage ELVSS may have a third voltage ELVSS_L or a fourth voltage ELVSS_H which is greater than a voltage level of the third voltage ELVSS_L during one frame period. The initialization voltage VINIT may have a fifth voltage VINIT_L or a sixth voltage VINIT_H which is greater than a voltage level of the fifth voltage VINIT_L.

The first voltage ELVDD_L and the third voltage ELVSS_L may have the same voltage level. The second voltage ELVDD_H and the fourth voltage ELVSS_H may have the same voltage level. The fifth voltage VINIT_L may have a voltage level that is less than voltage levels of the first voltage ELVDD_L and the third voltage ELVSS_L. The sixth voltage VINIT_H may have a voltage level that is greater than the voltage levels of the first voltage ELVDD_L and the third voltage ELVSS_L, but less than voltage levels of the second voltage ELVDD_H and the fourth voltage ELVSS_H.

A sustain voltage Vsus may be applied to the data line DL in the bias period P1, the initialization period P2, the compensation period P3, and the emission period P6, and a data signal DATA for grayscale representation may be supplied via the data line DL in the write period P4.

During a non-emission period of each of the first sub-frame 1SF, the second sub-frame 2SF, and the third sub-frame 3SF, i.e., during the bias period P1, the initialization period P2, the compensation period P3, and the write period P4, the second driving voltage ELVSS may have the fourth voltage ELVSS_H, and during the emission period P6, the second driving voltage ELVSS may have the third voltage ELVSS_L less than the fourth voltage ELVSS_H.

During the bias period P1, the first driving voltage ELVDD may have the second voltage ELVDD_H, the second driving voltage ELVSS may have the fourth voltage ELVSS_H, the initialization voltage VINIT may have the fifth voltage VINIT_L. During the bias period P1, each of a first gate signal GW supplied via the first gate line GWL, a second gate signal GC supplied via the second gate line GCL, a first emission control signal EM1 supplied via the first emission control line EML1, a second emission control signal EM2 supplied via the second emission control line EML2, and a third emission control signal EM3 supplied via the third emission control line EML3 may have an off voltage. Because each of the first gate signal GW, the second gate signal GC, the first emission control signal EM1, the second emission control signal EM2, and the third emission control signal EM3 has an off voltage, the second transistor T2, the third transistor T3, the first emission control transistor ET1, the second emission control transistor ET2, and the third emission control transistor ET3 may be turned off. A gate voltage of the first transistor T1 may be lowered by a coupling effect of the first capacitor Cst, and accordingly, the first transistor T1 may be turned on. In the bias period P1, due to the second driving voltage ELVSS being in a high voltage, the first to third display elements ED1, ED2, and ED3 may be in a non-emission state. By an on-bias applied to the gate of the first transistor T1 during the bias period P1, the hysteresis characteristic of the first transistor T1 may be improved.

During the initialization period P2, the first driving voltage ELVDD may have the first voltage ELVDD_L, the second driving voltage ELVSS may have the fourth voltage ELVSS_H, the initialization voltage VINIT may have the fifth voltage VINIT_L, the first gate signal GW and the second gate signal GC may have an on voltage. During the initialization period P2, the first emission control signal EM1, the second emission control signal EM2, and the third emission control signal EM3 may have an off voltage. By the turned-on first transistor T1, second transistor T2, and third transistor T3, the first transistor T1 may be diode-connected, and the first node N1 may be set to have a voltage (Vg=ELVDD_L-Vth) obtained by excluding a threshold voltage (Vth) of the first transistor T1 from the first voltage ELVDD_L, thereby initializing the gate of the first transistor T1.

During the compensation period P3, the first driving voltage ELVDD may have the second voltage ELVDD_H, the second driving voltage ELVSS may have the fourth voltage ELVSS_H, the initialization voltage VINIT may have the sixth voltage VINIT_H, the first gate signal GW and the second gate signal GC may have an on voltage. During the compensation period P3, the first emission control signal EM1, the second emission control signal EM2, and the third emission control signal EM3 may have an off voltage. Because the first gate signal GW and the second gate signal GC are in low voltages, i.e., each of the first gate signal GW and the second gate signal has an on voltage, the second transistor T2 and the third transistor T3 may be turned on. By the turned-on first transistor T1, second transistor T2, and third transistor T3, the first transistor T1 maintains being diode-connected, and the gate of the first transistor T1 may have a voltage (Vg=ELVDD_H-Vth) obtained by compensating for the threshold voltage (Vth) of the first transistor T1 from the second voltage ELVDD_H.

During the write period P4, the first driving voltage ELVDD may have the first voltage ELVDD_L, the second driving voltage ELVSS may have the fourth voltage ELVSS_H, the initialization voltage VINIT may have the sixth voltage VINIT_H. During the write period P4, the second gate signal GC, the first emission control signal EM1, the second emission control signal EM2, and the third emission control signal EM3 may have an off voltage. During the write period P4, the first gate signals GW[1] to GW[n] having the on voltage may be sequentially applied to the first gate lines GWL from a first row to an n^{th} row, and the data signals DATA may be applied to the data lines DL in synchronization with the first gate signals GW[1] to GW[n]. In other words, during the write period P4, the data signal DATA may be written sequentially in rows to the plurality of pixels PX.

During the write period P4 of the first sub-frame 1SF, the data signal DATA corresponding to the first display element ED1 may be applied through the data line DL in synchronization with the first gate signals GW[1] to GW[n] of each row. During the write period P4 of the second sub-frame 2SF, the data signal DATA corresponding to the second display element ED2 may be applied through the data line DL in synchronization with the first gate signals GW[1] to GW[n] of each row. During the write period P4 of the third sub-frame 3SF, the data signal DATA corresponding to the third display element ED3 may be applied through the data line DL in synchronization with the first gate signals GW[1] to GW[n] of each row.

According to an embodiment, the first display element ED1 may emit red light, the second display element ED2 may emit green light, and the third display element ED3 may emit blue light. During the write period P4 of the first sub-frame 1SF, red data signals R1 to Rn may be applied through the data line DL in synchronization with the first gate signals GW[1] to GW[n] of each row. During the write period P4 of the second sub-frame 2SF, green data signals G1 to Gn may be applied through the data line DL in synchronization with the first gate signals GW[1] to GW[n] of each row. During the write period P4 of the third sub-frame 3SF, blue data signals B1 to Bn may be applied through the data line DL in synchronization with the first gate signals GW[1] to GW[n] of each row.

In the write period P4, as the second gate signal GC, the first emission control signal EM1, the second emission control signal EM2, and the third emission control signal EM3 have the off voltage, the second transistor T2, the first emission control transistor ET1, the second emission control transistor ET2, and the third emission control transistor ET3 may be turned off. In contrast, the first gate signal GW has the on voltage during the write period P4, the third transistor T3 may be turned on. Accordingly, the first capacitor Cst and the second capacitor Cpr may be connected in series with each other, and charge sharing may occur between the first capacitor Cst and the second capacitor Cpr. Accordingly, the gate of the first transistor T1 may have a voltage (Vg=ELVDD_H-Vth+α×ΔVdata, where ΔVdata=Vdata−Vsus, and Vdata is a voltage corresponding to the data signal DATA) proportional to a capacitance ratio (α=Cpr/(Cpr+Cst)) of the first capacitor Cst and the second capacitor Cpr.

During the emission period P6, the first driving voltage ELVDD may have the second voltage ELVDD_H, the second driving voltage ELVSS may have the third voltage ELVSS_L, the initialization voltage VINIT may have the sixth voltage VINIT_H. During the emission period P6, each of the first gate signal GW and the second gate signal GC may have an off voltage. As the first gate signal GW and the second gate signal GC have the off voltage, the second transistor T2 and the third transistor T3 may be turned off.

During the emission period P6 of the first sub-frame 1SF, the first emission control signal EM1 may have an on voltage, and the second emission control signal EM2 and the third emission control signal EM3 may have an off voltage. Since the first emission control signal EM1 has the on voltage, the first emission control transistor ET1 may be turned on, and as the second emission control signal EM2 and the third emission control signal EM3 have the off voltage, the second emission control transistor ET2 and the third emission control transistor ET3 may be turned off. The first transistor T1 outputs a driving current corresponding to a gate-source voltage of the first transistor T1, and as the driving current flows to the first display element ED1, the pixel PX may emit red light. During the emission period P6 of the first sub-frame 1SF, the first display elements ED1 of all pixels PX disposed in the display unit 11 may emit light simultaneously. During the emission period P6 of the first sub-frame 1SF, the second display elements ED2 and the third display elements ED3 of all pixels PX may not emit light.

During the emission period P6 of the second sub-frame 2SF, the second emission control signal EM2 may have an on voltage, and the first emission control signal EM1 and the third emission control signal EM3 may have an off voltage. Since the second emission control signal EM2 has the on voltage, the second emission control transistor ET2 may be turned on, and as the first emission control signal EM1 and the third emission control signal EM3 have the off voltage, the first emission control transistor ET1 and the third emission control transistor ET3 may be turned off. The first transistor T1 outputs a driving current corresponding to a gate-source voltage of the first transistor T1, and as the driving current flows to the second display element ED2, the pixel PX may emit green light. During the emission period P6 of the second sub-frame 2SF, the second display elements ED2 of all pixels PX disposed in the display unit 11 may emit light simultaneously. During the emission period P6 of the second sub-frame 2SF, the first display elements ED1 and the third display elements ED3 of all pixels PX may not emit light.

During the emission period P6 of the third sub-frame 3SF, the third emission control signal EM3 may have an on voltage, and the first emission control signal EM1 and the second emission control signal EM2 may have an off voltage. Since the third emission control signal EM3 has the on voltage, the third emission control transistor ET3 may be turned on, and as the first emission control signal EM1 and the second emission control signal EM2 have the off voltage, the first emission control transistor ET1 and the second emission control transistor ET2 may be turned off. The first transistor T1 outputs a driving current corresponding to a gate-source voltage of the first transistor T1, and as the driving current flows to the third display element ED3, the pixel PX may emit blue light. During the emission period P6 of the third sub-frame 3SF, the third display elements ED3 of all pixels PX disposed in the display unit 11 may emit light simultaneously. During the emission period P6 of the third sub-frame 3SF, the first display elements ED1 and the second display elements ED2 of all pixels PX may not emit light.

The same first emission control signal EM1 may be supplied to the first emission control transistors ET1 of all of the plurality of pixels PX, the same second emission control signal EM2 may be supplied to the second emission control transistors ET2 of all of the plurality of pixels PX, and the same third emission control signal EM3 may be supplied to the third emission control transistors ET3 of all of the plurality of pixels PX. Here, supplying the same emission control signal to the emission control transistors of all of the plurality of pixels PX means that emission control signals with the same on-voltage period and the same off-voltage period are supplied to the emission control transistors of all of the plurality of pixels PX. Accordingly, the first display elements ED1 of all pixels PX may simultaneously emit light during the emission period P6 of the first sub-frame 1SF, the second display elements ED2 of all pixels PX may simultaneously emit light during the emission period P6 of the second sub-frame 2SF, and the third display elements ED3 of all pixels PX may simultaneously emit light during the emission period P6 of the third sub-frame 3SF.

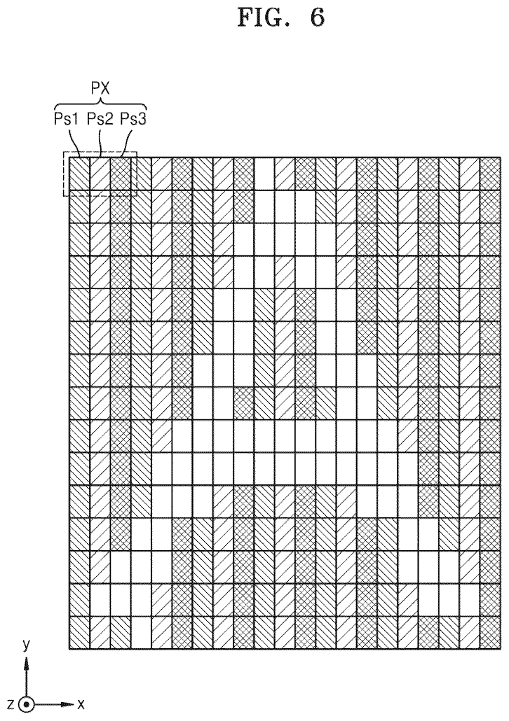

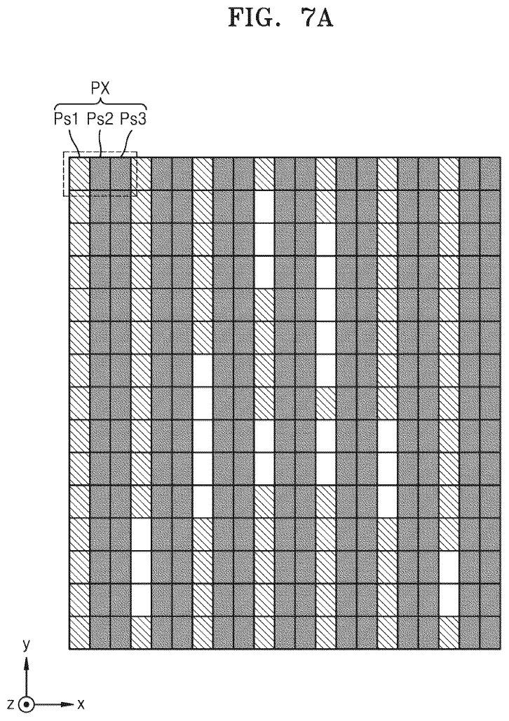

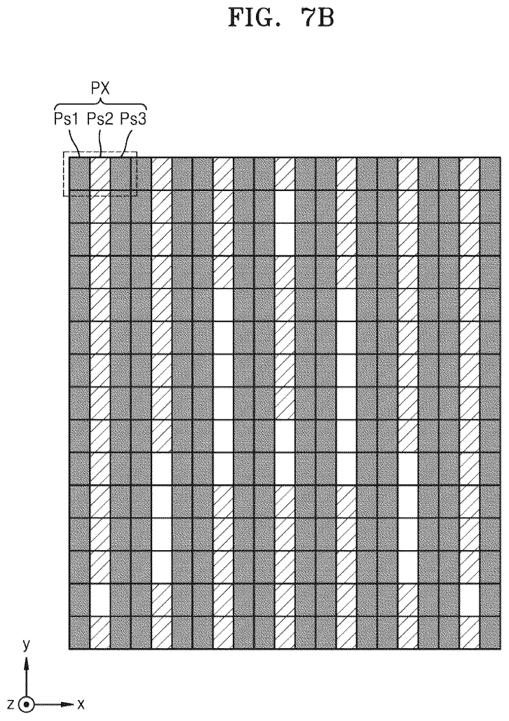

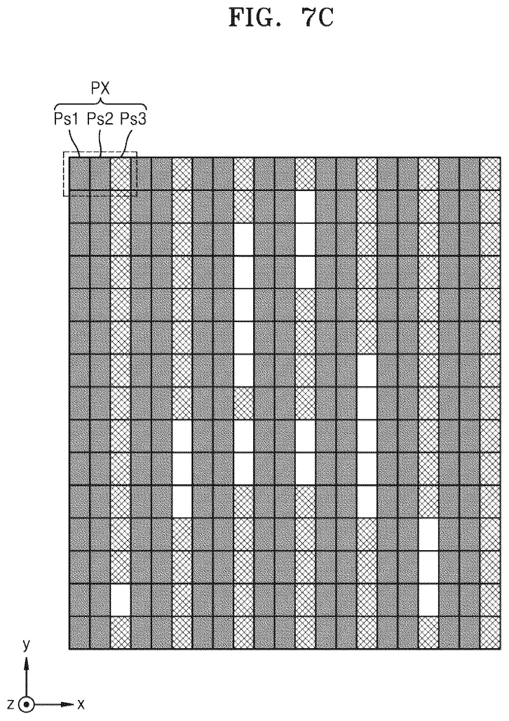

FIG. 6 is a diagram schematically illustrating an image displayed during a single frame, and FIGS. 7A to 7C are diagrams schematically illustrating images displayed during the respective sub-frames.

FIG. 6 shows that the display apparatus 10 displays the letter “A” during a single frame. The image of FIG. 6 is a superposition of the images displayed during the respective sub-frames, shown in FIGS. 7A to 7C.

Referring to FIG. 6, in the display apparatus 10, the plurality of pixels PX may be arranged in the first direction (x-direction) and the second direction (y-direction). Each of the pixels PX may include the first sub-pixel Ps1, the second sub-pixel Ps2, and the third sub-pixel Ps3, which emit light of different colors. A column including the first sub-pixels Ps1, a column including the second sub-pixels Ps2, and a column including the third sub-pixels Ps3 may be alternately arranged with each other along the first direction (x-direction).

Referring to FIG. 7A, during the emission period P6 of the first sub-frame 1SF, the first sub-pixels Ps1 of all pixels PX may emit light simultaneously. The second sub-pixels Ps2 and the third sub-pixels Ps3 of all pixels PX may not emit light. Accordingly, a red image may be displayed during the first sub-frame 1SF.

Referring to FIG. 7B, during the emission period P6 of the second sub-frame 2SF, the second sub-pixels Ps2 of all pixels PX may emit light simultaneously. The first sub-pixels Ps1 and the third sub-pixels Ps3 of all pixels PX may not emit light. Accordingly, a green image may be displayed during the second sub-frame 2SF.

Referring to FIG. 7C, during the emission period P6 of the third sub-frame 3SF, the third sub-pixels Ps3 of all pixels PX may emit light simultaneously. The first sub-pixels Ps1 and the second sub-pixels Ps2 of all pixels PX may not emit light. Accordingly, a blue image may be displayed during the third sub-frame 3SF.

The single frame 1F may be time-divided into the first sub-frame 1SF, the second sub-frame 2SF, and the third sub-frame 3SF so that the first sub-pixels Ps1, the second sub-pixels Ps2, and the third sub-pixels Ps3 may be sequentially driven. Since the time required to sequentially drive the first sub-pixels Ps1, the second sub-pixels Ps2, and the third sub-pixels Ps3 is very short, a user may recognize a full color image, such as the superimposed images of the respective sub-frames, e.g., a red image, a green image, and a blue image, as shown in FIG. 6.

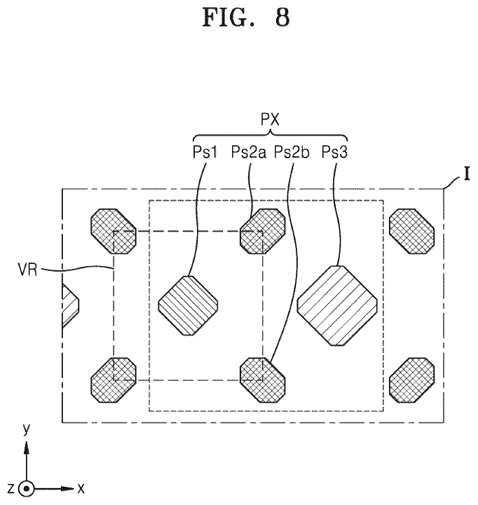

FIG. 8 is a plan view illustrating region I of the display apparatus 10 shown in FIG. 1.

Referring to FIG. 8, the plurality of pixels PX may be disposed in the display area DA of the display apparatus 10. The pixels PX may be arranged in the first direction (x-direction) and the second direction (y-direction).

A single pixel PX may include four sub-pixels Ps1, Ps2a, Ps2b, and Ps3. In an embodiment, the first sub-pixel Ps1 may emit red light, the second-1 sub-pixel Ps2a and the second-2 sub-pixel Ps2b may emit green light, and the third sub-pixel Ps3 may emit blue light. Each of the sub-pixels Ps1, Ps2a, Ps2b, and Ps3 shown in FIG. 8 indicates an emission area of a corresponding display element.

According to an embodiment, the pixels PX may be disposed in a PenTile™ array. For example, the two sub-pixels Ps2a and Ps2b emitting green light may be disposed at four corners of an imaginary rectangle VR, and the first sub-pixel Ps1 or the third sub-pixel Ps3 may be disposed in a central portion of the imaginary rectangle VR. Because the pixels PX are disposed in a PenTile™ array, a high-resolution display apparatus 10 may be implemented.

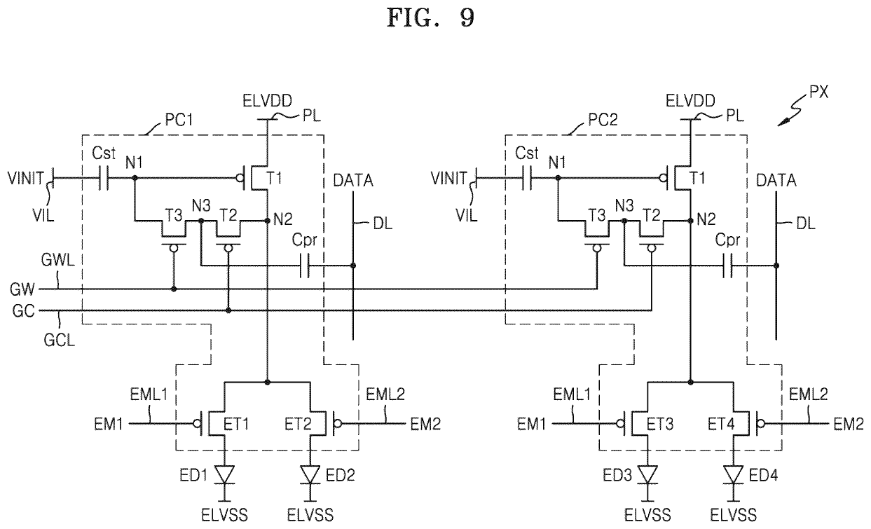

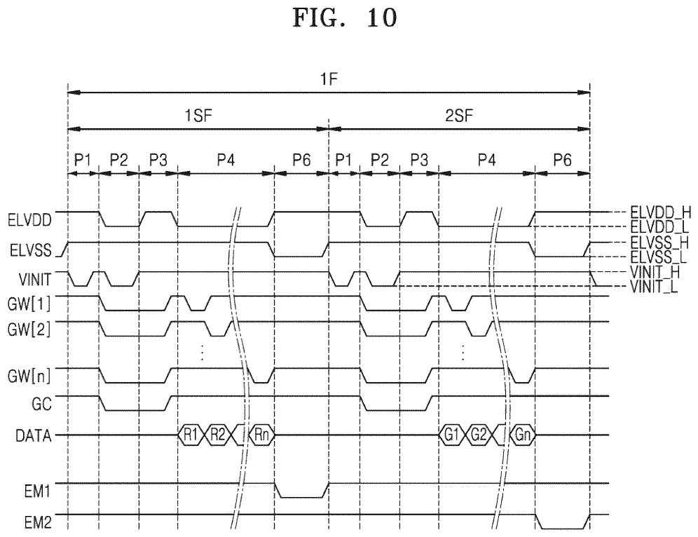

FIG. 9 is an equivalent circuit diagram schematically illustrating a pixel PX according to an embodiment, and FIG. 10 is a timing diagram showing driving of the pixel PX shown in FIG. 9.

Referring to FIG. 9, the pixel PX may include a first pixel circuit PC1, a second pixel circuit PC2, the first display element ED1, the second display element ED2, the third display element ED3, and a fourth display element ED4. The first display element ED1 and the second display element ED2 are connected to the first pixel circuit PC1, and the third display element ED3 and the fourth display element ED4 are connected to the second pixel circuit PC2. Each of the first display element ED1, the second display element ED2, the third display element ED3, and the fourth display element ED4 may be an organic light-emitting diode.

According to an embodiment, the first display element ED1 may constitute the first sub-pixel Ps1 emitting red light, the second display element ED2 may constitute the second-1 sub-pixel Ps2a emitting green light, the third display element ED3 may constitute the third sub-pixel Ps3 emitting blue light, and the fourth display element ED4 may constitute the second-2 sub-pixel Ps2b emitting green light. In an embodiment, the first display element ED1 may constitute the first sub-pixel Ps1 emitting red light, the second display element ED2 may constitute the third sub-pixel Ps3 emitting blue light, the third display element ED3 may constitute the second-1 sub-pixel Ps2a emitting green light, and the fourth display element ED4 may constitute the second-2 sub-pixel Ps2b emitting green light.

The first pixel circuit PC1 may include a first transistor T1, a second transistor T2, a third transistor T3, a first emission control transistor ET1, a second emission control transistor ET2, a first capacitor Cst, and a second capacitor Cpr, which are connected to a plurality of signal lines. The second pixel circuit PC2 may include a first transistor T1, a second transistor T2, a third transistor T3, a third emission control transistor ET3, a fourth emission control transistor ET4, a first capacitor Cst, and a second capacitor Cpr, which are connected to a plurality of signal lines. The signal lines may include data line DL, a first gate line GWL, a second gate line GCL, an initialization voltage line VIL, a first emission control line EML1, a second emission control line EML2, and a driving voltage line PL. The first gate line GWL, the second gate line GCL, the first emission control line EML1, and the second emission control line EML2 may be gate control lines to which a gate signal for turning-on and turning-off a transistor is transmitted. The first pixel circuit PC1 and the second pixel circuit PC2 may have substantially the same or similar configurations. Hereinbelow, the first pixel circuit PC1 is mainly described for convenience of explanation.

According to an embodiment, the transistors included in the first pixel circuit PC1 and the second pixel circuit PC2 may be p-type silicon thin-film transistors. The silicon thin-film transistor may be an LTPS thin-film transistor in which an active pattern (semiconductor layer) includes amorphous silicon, polysilicon, or the like.

The first transistor T1 may be a driving transistor, and the second transistor T2, the third transistor T3, the first emission control transistor ET1, the second emission control transistor ET2, the third emission control transistor ET3, and the fourth emission control transistor ET4 may be switching transistors. A first terminal (first electrode) of each of the first transistor T1, the second transistor T2, the third transistor T3, the first emission control transistor ET1, the second emission control transistor ET2, the third emission control transistor ET3, and the fourth emission control transistor ET4 may be a source or a drain, and a second terminal (second electrode) may be a different terminal than the first terminal.

The first transistor T1 may be connected to the driving voltage line PL. The first transistor T1 may include a gate connected to a first node N1, a first terminal connected to the driving voltage line PL, and a second terminal connected to a second node N2.

The second transistor T2 may be connected between the second node N2 and a third node N3. The second transistor T2 may include a gate connected to the second gate line GCL, a first terminal connected to the second node N2, and a second terminal connected to the third node N3.

The third transistor T3 may be connected in series with the second transistor T2. The third transistor T3 may be connected between the third node N3 and the first node N1. The third transistor T3 may include a gate connected to the first gate line GWL, a first terminal connected to the third node N3, and a second terminal connected to the first node N1.

The first emission control transistor ET1 may be connected between the second node N2 and the first display element ED1. The first emission control transistor ET1 may include a gate connected to the first emission control line EML1, a first terminal connected to the second node N2, and a second terminal connected to the first display element ED1.

The second emission control transistor ET2 may be connected between the second node N2 and the second display element ED2. The second emission control transistor ET2 may include a gate connected to the second emission control line EML2, a first terminal connected to the second node N2, and a second terminal connected to the second display element ED2.

The second pixel circuit PC2 may include the third emission control transistor ET3 and the fourth emission control transistor ET4. The third emission control transistor ET3 may be connected between the second node N2 of the second pixel circuit PC2 and the third display element ED3. The third emission control transistor ET3 may include a gate connected to the first emission control line EML1, a first terminal connected to the second node N2 of the second pixel circuit PC2, and a second terminal connected to the third display element ED3.

The fourth emission control transistor ET4 may be connected between the second node N2 of the second pixel circuit PC2 and the fourth display element ED4. The fourth emission control transistor ET4 may include a gate connected to the second emission control signal line EML2, a first terminal connected to the second node N2 of the second pixel circuit PC2, and a second terminal connected to the fourth display element ED4.

The first capacitor Cst may be connected between the first node N1 and the initialization voltage line VIL. The first capacitor Cst may include a first electrode connected to the first node N1 and a second electrode connected to the initialization voltage line VIL.

The second capacitor Cpr may be connected between the data line DL and the third node N3. The second capacitor Cpr may include a first electrode connected to the data line DL and a second electrode connected to the third node N3. A capacitance of the second capacitor Cpr may be greater than a capacitance of the first capacitor Cst.

Each of the first display element ED1, the second display element ED2, the third display element ED3, and the fourth display element ED4 may include a pixel electrode, an opposite electrode, and an intermediate layer disposed between the pixel electrode and the opposite electrode. The opposite electrode may receive the second driving voltage ELVSS.

The pixel PX may display an image for each frame period. Referring to FIG. 10, a single frame 1F may include a plurality of sub-frames. For example, the single frame 1F may include the first sub-frame 1SF and the second sub-frame 2SF.

Each of the first sub-frame 1SF and the second sub-frame 2SF may include the bias period P1, the initialization period P2, the compensation period P3, the write period P4, and the emission period P6. The bias period P1, the initialization period P2, the compensation period P3, and the write period P4 may be non-emission periods in which none of the pixels PX emit light. During the bias period P1, the initialization period P2, the compensation period P3, and the emission period P6, all of the pixels PX disposed in the display unit 11 may be driven simultaneously, and during the write period P4, the pixels PX disposed in the display unit 11 may be sequentially driven in rows.

The first driving voltage ELVDD supplied via the driving voltage line PL, the initialization voltage VINIT supplied via the initialization voltage line VIL, and the second driving voltage ELVSS supplied to the opposite electrode may have voltage levels that vary within one frame period.

The sustain voltage Vsus may be applied to the data line DL during the bias period P1, the initialization period P2, the compensation period P3 and the emission period P6, and the data signal DATA for grayscale representation may be supplied via the data line DL in the write period P4.

During the non-emission period of each of the first sub-frame 1SF, and the second sub-frame 2SF, i.e., during the bias period P1, the initialization period P2, the compensation period P3, and the write period P4, the second driving voltage ELVSS may have the fourth voltage ELVSS_H, and during the emission period P6, the second driving voltage ELVSS may have the third voltage ELVSS_L less than the fourth voltage ELVSS_H.

During the bias period P1, the first driving voltage ELVDD may have the second voltage ELVDD_H, the second driving voltage ELVSS may have the fourth voltage ELVSS_H, the initialization voltage VINIT may have the fifth voltage VINIT_L. During the bias period P1, each of the first gate signal GW supplied via the first gate line GWL, the second gate signal GC supplied via the second gate line GCL, the first emission control signal EM1 supplied via the first emission control line EML1, and the second emission control signal EM2 supplied via the second emission control line EML2 may have an off voltage. Since the first gate signal GW, the second gate signal GC, the first emission control signal EM1 and the second emission control signal EM2 have the off voltage, the second transistor T2, the third transistor T3, and the first to fourth emission control transistors ET1, ET2, ET3, and ET4 may be turned off. The gate voltage of the first transistor T1 may be lowered by the coupling effect of the first capacitor Cst, and accordingly, the first transistor T1 may be turned on. In the bias period P1, because the second driving voltage ELVSS is a high voltage, the first to fourth display elements ED1, ED2, ED3, and ED4 may be in a non-emission state. By an on-bias applied to the gate of the first transistor T1 during the bias period P1, the hysteresis characteristic of the first transistor T1 may be improved.

During the initialization period P2, the first driving voltage ELVDD may have the first voltage ELVDD_L, the second driving voltage ELVSS may have the fourth voltage ELVSS_H, the initialization voltage VINIT may have the fifth voltage VINIT_L. During the initialization period P2, the first gate signal GW and the second gate signal GC may have an on voltage, and the first emission control signal EM1 and the second emission control signal EM2 may have an off voltage. Due to the turned-on first transistor T1, second transistor T2, and third transistor T3, the first transistor T1 may be diode-connected, and the first node N1 may be set to a voltage (Vg=ELVDD_L-Vth) obtained by excluding the threshold voltage (Vth) of the first transistor T1 from the first voltage ELVDD_L, thereby initializing the gate of the first transistor T1.

During the compensation period P3, the first driving voltage ELVDD may have the second voltage ELVDD_H, the second driving voltage ELVSS may have the fourth voltage ELVSS_H, the initialization voltage VINIT may have the sixth voltage VINIT_H. During the compensation period P3, the first gate signal GW and the second gate signal GC may have an on voltage, and the first emission control signal EM1 and the second emission control signal EM2 may have an off voltage. Since the first gate signal GW and the second gate signal GC have the on voltage, the second transistor T2 and the third transistor T3 may be turned on. Because of the turned-on first transistor T1, second transistor T2, and third transistor T3, the first transistor T1 maintains being diode-connected, and the gate of the first transistor T1 may have a voltage (Vg=ELVDD_H-Vth) obtained by compensating for the threshold voltage (Vth) of the first transistor T1 from the second voltage ELVDD_H.

During the write period P4, the first driving voltage ELVDD may have the first voltage ELVDD_L, the second driving voltage ELVSS may have the fourth voltage ELVSS_H, the initialization voltage VINIT may have the sixth voltage VINIT_H. During the write period P4, the second gate signal GC, the first emission control signal EM1, and the second emission control signal EM2 may have an off voltage. The first gate signals GW[1] to GW[n] having the on voltage may be sequentially applied via the first gate lines GWL from the first row to the n^{th} row, and the data signals DATA may be applied via the data lines DL in synchronization with the first gate signals GW[1] to GW[n]. In other words, during the write period P4, the data signal DATA may be written sequentially in rows to the plurality of pixels PX.

During the write period P4 of the first sub-frame 1SF, in synchronization with the first gate signals GW[1] to GW[n] of each row, the data signal DATA corresponding to the first display element ED1 may be applied through the data line DL of the first pixel circuit PC1, and the data signal DATA corresponding to the third display element ED3 may be applied through the data line DL of the second pixel circuit PC2. During the write period P4 of the second sub-frame 2SF, in synchronization with the first gate signals GW[1] to GW[n] of each row, the data signal DATA corresponding to the second display element ED2 may be applied through the data line DL of the first pixel circuit PC1, and the data signal DATA corresponding to the fourth display element ED4 may be applied through the data line DL of the second pixel circuit PC2.

According to an embodiment, the first display element ED1 may emit red light, the third display element ED3 may emit blue light, and the second display element ED2 and the fourth display element ED4 may emit green light. During the write period P4 of the first sub-frame 1SF, in synchronization with the first gate signals GW[1] to GW[n] of each row, the red data signals R1 to Rn may be applied through the data line DL of the first pixel circuit PC1, and the blue data signals may be applied through the data line DL of the second pixel circuit PC2. During the write period P4 of the second sub-frame 2SF, in synchronization with the first gate signals GW[1] to GW[n] of each row, the first green data signals G1 to Gn may be applied through the data line DL of the first pixel circuit PC1, and the second green data signals may be applied through the data line DL of the second pixel circuit PC2.

During the write period P4, since the second gate signal GC, the first emission control signal EM1 and the second emission control signal EM2 have the off voltage, the first to fourth emission control transistors ET1, ET2, ET3, and ET4 may be turned off, and as the first gate signal GW has the on voltage, the third transistor T3 may be turned on. Accordingly, the first capacitor Cst and the second capacitor Cpr may be connected in series with each other, and charge sharing may occur between the first capacitor Cst and the second capacitor Cpr. Accordingly, the gate of the first transistor T1 may have a voltage (Vg=ELVDD_H−Vth+α×ΔVdata, where ΔVdata=Vdata−Vsus, and Vdata is a voltage corresponding to the data signal DATA) proportional to a capacitance ratio (a=Cpr/(Cpr+Cst)) of the first capacitor Cst and the second capacitor Cpr.

During the emission period P6, the first driving voltage ELVDD may have the second voltage ELVDD_H, the second driving voltage ELVSS may have the third voltage ELVSS_L, the initialization voltage VINIT may have the sixth voltage VINIT_H. During the emission period P6, the first gate signal GW and the second gate signal GC may have an off voltage. Because the first gate signal GW and the second gate signal GC have the off voltage, the second transistor T2 and the third transistor T3 may be turned off.

During the emission period P6 of the first sub-frame 1SF, the first emission control signal EM1 may have an on voltage, and the second emission control signal EM2 may have an off voltage. Since the first emission control signal EM1 has the on voltage, the first emission control transistor ET1 and the third emission control transistor ET3 may be turned on, and as the second emission control signal EM2 has the off voltage, the second emission control transistor ET2 and the fourth emission control transistor ET4 may be turned off. The first transistor T1 of each of the first pixel circuit PC1 and the second pixel circuit PC2 may output a driving current corresponding to the gate-source voltage of the first transistor T1. As the driving current of the first pixel circuit PC1 flows to the first display element ED1 and the driving current of the second pixel circuit PC2 flows to the third display element ED3, the pixel PX may emit red light and blue light. During the emission period P6 of the first sub-frame 1SF, the first display elements ED1 and the third display elements ED3 of all pixels PX disposed in the display unit 11 may emit light simultaneously. During the emission period P6 of the first sub-frame 1SF, the second display elements ED2 and the fourth display elements ED4 of all pixels PX may not emit light. Accordingly, the display apparatus 10 may display a red image and a blue image during the emission period P6 of the first sub-frame 1SF.

During the emission period P6 of the second sub-frame 2SF, the second emission control signal EM2 may have an on voltage, and the first emission control signal EM1 may have an off voltage. Since the second emission control signal EM2 has the on voltage, the second emission control transistor ET2 and the fourth emission control transistor ET4 may be turned on, and as the first emission control signal EM1 has the off voltage, the first emission control transistor ET1 and the third emission control transistor ET3 may be turned off. The first transistor T1 of each of the first pixel circuit PC1 and the second pixel circuit PC2 may output a driving current corresponding to the gate-source voltage of the first transistor T1. As the driving current of the first pixel circuit PC1 flows to the second display element ED2 and the driving current of the second pixel circuit PC2 flows to the fourth display element ED4, the pixel PX may emit green light. During the emission period P6 of the second sub-frame 2SF, the second display elements ED2 and the fourth display elements ED4 of all pixels PX may emit light simultaneously. During the emission period P6 of the second sub-frame 2SF, the first display elements ED1 and the third display elements ED3 of all pixels PX may not emit light. Accordingly, the display apparatus 10 may display a green image during the emission period P6 of the second sub-frame 2SF.

When the first display element ED1 may emit red light, the second display element ED2 may emit blue light, and the third display element ED3 and the fourth display element ED4 may emit green light, the display apparatus 10 may display a red image and a green image during the emission period P6 of the first sub-frame 1SF, and display a blue image and a green image during the emission period P6 of the second sub-frame 2SF. Because the time required to sequentially drive display elements is very short, the user may recognize a full color image, such as superimposed images of the respective sub-frames.

According to an embodiment of the present disclosure, a plurality of display elements may share some transistors and capacitors, thereby obtaining the high-resolution display apparatus 10.

According to an embodiment of the present disclosure as described above, a display apparatus having an improved resolution may be implemented by reducing an area occupied by a pixel circuit. However, the scope of the present disclosure is not limited by this effect.

It should be understood that embodiments described herein should be considered in a descriptive sense only and not for purposes of limitation. Descriptions of features or aspects within each embodiment should typically be considered as available for other similar features or aspects in other embodiments. While the present disclosure has been described with reference to the drawings and embodiments thereof, it will be understood by those of ordinary skill in the art that various changes in form and details may be made thereto without departing from the spirit and scope of the present disclosure as set forth and defined by the following claims.

What is claimed is:

1. A display apparatus comprising:
a plurality of gate control lines;
a plurality of data lines; and
a plurality of pixels connected to the gate control lines and the data lines,
wherein each of the plurality of pixels comprises:
first display element, second display element and third display element, each of the first to third display elements emitting light of different colors;
a first transistor having a gate connected to a first node, a first terminal connected to a first voltage line, and a second terminal connected to a second node;
a first emission control transistor connected between the second node and the first display element;
a second emission control transistor connected between the second node and the second display element; and
a third emission control transistor connected between the second node and the third display element, and
wherein a same first emission control signal is supplied to the first emission control transistor included in each of the plurality of pixels, a same second emission control signal is supplied to the second emission control transistor included in each of the plurality of pixels, and a same third emission control signal is supplied to the third emission control transistor included in each of the plurality of pixels.

2. The display apparatus of claim 1, wherein a single frame comprises first sub-frame, second sub-frame and third sub-frame,
the first sub-frame comprises a first non-emission period in which a data signal corresponding to the first display element is written, and a first emission period in which the first display element emits light,
the second sub-frame comprises a second non-emission period in which a data signal corresponding to the second display element is written, and a second emission period in which the second display element emits light, and
the third sub-frame comprises a third non-emission period in which a data signal corresponding to the third display element is written, and a third emission period in which the third display element emits light.

3. The display apparatus of claim 2, wherein data signals are sequentially written to the plurality of pixels for each row during the first to third non-emission periods.

4. The display apparatus of claim 2, wherein the first display element in each of the plurality of pixels simultaneously emits light during the first emission period, the second display element in each of the plurality of pixels simultaneously emits light during the second emission period, and the third display element in each of the plurality of pixels simultaneously emits light during the third emission period.

5. The display apparatus of claim 1, wherein each of the plurality of pixels further comprises:
a second transistor connected between the second node and a third node;
a third transistor connected between the first node and the third node;
a first capacitor connected between an initialization voltage line and the first node; and
a second capacitor connected between a data line and the third node.

6. The display apparatus of claim 5, wherein a first driving voltage supplied via the first voltage line has a variable voltage level.

7. The display apparatus of claim 5, wherein each of the first to third display elements comprises a pixel electrode, an opposite electrode disposed on the pixel electrode, and an intermediate layer disposed between the pixel electrode and the opposite electrode, and
a second driving voltage supplied to the opposite electrode has a first voltage during the first non-emission period, the second non-emission period, and the third non-emission period, and a second voltage during the first emission period, the second emission period, and the third emission period, and
the second voltage of the second driving voltage is lower than the first voltage of the second driving voltage.

8. The display apparatus of claim 5, wherein the initialization voltage supplied via the initialization voltage line has a variable voltage level.

9. The display apparatus of claim 1, wherein a column in which the first display element is arranged, a column in which the second display element is arranged, and a column in which the third display element is arranged are alternately disposed with each other in a row direction.

10. A display apparatus comprising:
a plurality of gate control lines;
a plurality of data lines; and
a plurality of pixels connected to the gate control lines and the data lines,
wherein each of the plurality of pixels comprises:
first display element, second display element, third display element and fourth display element, each of the first to fourth display elements emitting light of one color among a first color, a second color, and a third color, wherein the first color, the second color, and the third color are different colors;
a first pixel circuit comprising a first transistor connected to a first voltage line, a first emission control transistor connected between the first transistor and the first display element, and a second emission control transistor connected between the first transistor and the second display element; and
a second pixel circuit comprising a first transistor connected to the first voltage line, a third emission control transistor connected between the first transistor and the third display element, and a fourth emission control transistor connected between the first transistor and the fourth display element, and
wherein a same first emission control signal is supplied to the first emission control transistor and the third emission control transistor included in each of the plurality of pixels, and a same second emission control signal is supplied to the second emission control transistor and the fourth emission control transistor included in each of the plurality of pixels.

11. The display apparatus of claim 10, wherein a single frame comprises first sub-frame and second sub-frame,
the first sub-frame comprises a first non-emission period in which a data signal corresponding to the first display element and the third display element is written, and a first emission period in which the first display element and the third display element emit light, and
the second sub-frame comprises a second non-emission period in which a data signal corresponding to the second display element and the fourth display element is written, and a second emission period in which the second display element and the fourth display element emit light.

12. The display apparatus of claim 11, wherein, during each of the first non-emission period and the second non-emission period, data signals are sequentially written to the plurality of pixels for each row.

13. The display apparatus of claim 11, wherein the first display element and the third display element in each of the plurality of pixels simultaneously emit light during the first emission period, and the second display element and the fourth display element in each of the plurality of pixels simultaneously emit light during the second emission period.

14. The display apparatus of claim 10, wherein the first transistor has a gate connected to a first node, a first terminal connected to the first voltage line, and a second terminal connected to a second node, and
each of the first pixel circuit and the second pixel circuit comprises:
a second transistor connected between the second node and a third node;
a third transistor connected between the first node and the third node;
a first capacitor connected between an initialization voltage line and the first node; and
a second capacitor connected between a data line and the third node.

15. The display apparatus of claim 14, wherein a first driving voltage supplied via the first voltage line has a variable voltage level.

16. The display apparatus of claim 14, wherein each of the first to fourth display elements comprises a pixel electrode, an opposite electrode disposed on the pixel electrode, and an intermediate layer disposed between the pixel electrode and the opposite electrode, and
a second driving voltage supplied to the opposite electrode has a first voltage during the first non-emission period, and the second non-emission period, and a second voltage, during the first emission period, and the second emission period, and
the second voltage of the second driving voltage is lower than the first voltage of the second driving voltage.

17. The display apparatus of claim 10, wherein the first display element emits red light, the second display element emits blue light, and the third display element and the fourth display element emit green light.

18. The display apparatus of claim 10, wherein the first display element emits red light, the third display element emits blue light, and the second display element and the fourth display element emit green light.

19. An electronic device comprising:
a processor providing input image data; and
a display apparatus displaying an image based on the input image data,
wherein the display apparatus comprises a plurality of pixels connected to gate control lines and data lines,
wherein each of the plurality of pixels comprises:
first display element, second display element and third display element, each of the first to third display elements emitting light of different colors;
a first transistor having a gate connected to a first node, a first terminal connected to a first voltage line, and a second terminal connected to a second node;
a first emission control transistor connected between the second node and the first display element;
a second emission control transistor connected between the second node and the second display element; and
a third emission control transistor connected between the second node and the third display element, and
wherein a same first emission control signal is supplied to the first emission control transistor included in each of the plurality of pixels, a same second emission control signal is supplied to the second emission control transistor included in each of the plurality of pixels, and a same third emission control signal is supplied to the third emission control transistor included in each of the plurality of pixels.

20. The electronic device of claim 19,
wherein the display apparatus is included in one of a mobile phone, a smartphone, a tablet personal computer (PC), a mobile communication terminal, an electronic notebook, an electronic book, a portable multimedia player, a navigation, an ultra mobile PC, a television, a laptop, a monitor, a billboard, an Internet of things device, a smart watch, a watch phone, a glasses-type display, a head-mounted display, an instrument panel for a vehicle, a center fascia for a vehicle, a center information display, and a room-mirror display for a vehicle.
